(19) United States
(12) Patent Application Publication
(10) Pub. No.: US 2024/0262077 A1
(43) Pub. Date: Aug. 8, 2024

(54) PACKAGING MATERIALS WITH SEALED EDGES AND PACKAGING SYSTEMS

(71) Applicant: PAC WORLDWIDE CORPORATION, Redmond, WA (US)

(72) Inventors: Jeffrey Joseph STIMLER, Mason, OH (US); Paul Andrew FREDERICK, Harrison, OH (US); Elisa Leanna Super WORRALL, Liberty Township, OH (US)

(21) Appl. No.: 18/564,992

(22) PCT Filed: May 31, 2022
(86) PCT No.: PCT/US2022/031568

§ 371 Date: Nov. 28, 2023

Related U.S. Application Data
(60) Provisional application No. 63/195,539, filed on Jun. 1, 2021.

(51) Int. Cl. B32B 7/027; B32B 3/04; B32B 3/28; B32B 7/05; B32B 15/08; B32B 15/20

(52) U.S. Cl. CPC B32B 7/027; B32B 3/04; B32B 3/28; B32B 7/05; B32B 15/08; B32B 15/20; B32B 2307/304; B32B 2307/7376; B32B 2311/24; B32B 2439/06

(57) ABSTRACT

The present disclosure is directed to an insulating sheet material including a first metallized layer, a second layer including a plurality of air pockets on the first layer, and a third layer on the second layer. The first metallized layer includes a metallic layer on a polymeric layer, and the second and third layers are polymeric layers as well. In some embodiments, the polymeric layer of the first layer, the second polymeric layer, and the third polymeric layer are melted and fused together at edges of the first, second, and third layers forming an insulating sheet material. A package liner is made of a first insulating sheet material, a second insulating sheet material, and a third insulating sheet material having edges that are melted and fused together. A package includes a first insulating sheet material and a second insulating sheet material having edges that are melted and fused together.

### BACKGROUND

### Technical Field

The present disclosure relates generally to packaging materials and packaging systems, and more particularly to packaging materials and packaging systems that include metallized polymer layers and sealed edges.

### Description of the Related Art

Metallized polymer layers are widely available in various forms and are used in various applications. As examples, metallized polymer layers are often used as decorative or insulating materials. Metallized polymer layers may include polyester, polypropylene, polyethylene, or polyethylene terephthalate metallized with aluminum, nickel, or chromium. Metallized polymer layers are often fabricated using physical vapor deposition processes, in which a metal is heated, melted, and boiled or evaporated, sometimes in a vacuum, and is then allowed to condense onto a cold, sometimes statically charged, polymer layer. Metallized polymer layers can have very thin metallic layers.

### BRIEF SUMMARY

A packaging material system may be summarized as comprising a metallized layer that may include a metallic layer and a first polymeric layer. A second layer including a plurality of gas-filled polyethylene bubbles coupled to the first polymeric layer of the metallized layer. The second layer may be a second polymeric layer. A third layer may be on the second layer. The third layer may be a third polymeric layer. A surface of the metallic layer of the metallized layer faces away from the first polymeric layer of the metallized layer. The metallic layer may be exposed to an environment surrounding the packaging material system. The metallic layer may comprise aluminum.

The system may be recyclable, thermally insulating, and/or a package or package liner that encloses perishable goods, such as food. The system may be a barrier to O₂ and/or H₂O. In some embodiments, the system may include polyester, polypropylene, and/or polyethylene terephthalate. However, in some alternative embodiments, the system may include materials different than polyester, polypropylene, and/or polyethylene. For example, the materials may be in combination with the polyester, polypropylene, and/or polyethylene, or the different materials may replace the polyester, polypropylene, and/or polyethylene.

The plurality of gas-filled polyethylene bubbles are attached directly to the metallized layer and the third layer. The third layer being opposite to the first polymeric layer.

When utilized in the package material system, the first metallized layer may be exposed to an environment surrounding the system, and the third layer may be within and partially define a cavity of the package or the package liner. Foodstuffs or a perishable product may be placed within the cavity for shipping within the package material system, which may be an embodiment of the package or package liner.

A method of fabricating a packaging material system may comprise: coupling a first metallized layer including a metallic layer and a first polymeric layer to a first side of a second layer such that a surface of the metallic layer faces away from the second layer; coupling a third layer to the second layer opposite to the first metallized layer; and sealing edges of the first metallized layer to the third layer.

### BRIEF DESCRIPTION OF THE SEVERAL VIEWS OF THE DRAWINGS

For a better understanding of the embodiments, reference will now be made by way of example to the accompanying drawings.

In the drawings, identical reference numbers identify similar elements or acts unless the context indicates otherwise.

The sizes and relative proportions of the elements in the drawings are not necessarily drawn to scale. For example, some of these elements may be enlarged and positioned to improve drawing legibility.

FIG. 1A illustrates an exploded view of layers of an embodiment of an insulating sheet material of the present disclosure;

FIG. 1B illustrates the embodiment of the insulating sheet material of the present disclosure as shown in FIG. 1A;

FIG. 1C illustrates a zoomed-in enhanced view of an encircled bubble or air-pocket as shown in FIG. 1B;

FIG. 2A illustrates a front plan view of an embodiment of a package liner of the present disclosure;

FIG. 2B is a bottom plan view of the embodiment of the package liner of the present disclosure as shown in FIG. 2A;

FIG. 2C is a top plan view of the embodiment of the package liner of the present disclosure as shown in FIGS. 2A and 2B;

FIG. 2D is a cross-sectional view taken along line A-A as shown in FIG. 1A of the embodiment of the package liner of the present disclosure as shown in FIGS. 2A-2D;

FIG. 3 is a perspective view of an embodiment of a package of the present disclosure;

FIG. 4 is a flowchart of an embodiment of a method of manufacturing an embodiment of an insulating material of the present disclosure;

FIG. 5 is a flowchart of an embodiment of a method of manufacturing an alternative embodiment of an insulating material of the present disclosure;

FIG. 6 is a flowchart of an embodiment of a method of manufacturing a package liner utilizing an embodiment of an insulating material of the present disclosure;

FIG. 7 is directed to a graph illustrating data collected for various samples of packaging within the scope of the present disclosure;

FIG. 8 is directed to a graph illustrating data collected for various samples of packaging within the scope of the present disclosure;

FIG. 9 is directed to a graph illustrating data collect for various samples of packaging within the scope of the present disclosure; and

FIG. 10 is directed to various embodiments of bubbles or air-pockets utilized in embodiments of insulating material of the present disclosure.

### DETAILED DESCRIPTION

In the following description, certain specific details are set forth in order to provide a thorough understanding of various embodiments of the disclosure. However, one skilled in the art will understand that the disclosure may be practiced without these specific details. In other instances, well-known structures and components associated with shipping containers or forming shipping containers have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

The use of ordinals such as first, second, third, fourth, etc., does not necessarily imply a ranked sense of order, but rather may only distinguish between multiple instances of an act or structure.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms “top,” “bottom,” “upper,” “lower,” “vertical,” “horizontal,” “left,” and “right,” are used for only discussion purposes based on the orientation of the components in the discussion of the Figures in the present disclosure as follows. These terms are not limiting as to the possible positions explicitly disclosed, implicitly disclosed, or inherently disclosed in the present disclosure.

The term “substantially” is used to clarify that there may be slight differences or variations as for when a surface is coplanar with another surface in the real world, as nothing can be made perfectly equal or perfectly the same. In other words, substantially means that there may be some slight variation in actual practice, and instead, is made within accepted tolerances.

As used in this specification and the appended claims, the singular forms “a,” “an,” and “the” include plural referents unless the content clearly dictates otherwise.

The present disclosure is directed to embodiments of insulating materials utilized in forming packages or package liners for keeping foodstuffs or other perishable products at a specific temperature while shipping the foodstuffs or products to a customer or an end user. For example, the insulating materials may be utilized for cold-chain applications as a box, package, or container liner within a box to keep foodstuffs at a cold enough temperature such that the foodstuffs being shipped does not become rancid, rotten, or unusable before receipt by the customer.

In at least one embodiment of an insulating sheet material of the present disclosure, the insulating sheet material includes a metallized polymeric layer, a first polymeric layer having edges sealed to edges of the metallized polymeric layer, and a second polymeric layer including a layer of air pockets positioned between (e.g., sandwiched between) the metallized polymeric layer and the first polymeric layer. The sealed edges are around the layer of air pockets in the second polymeric layer. The sealed edges of the metallized and the first polymeric layers in combination with the air pockets of the second polymeric layer may increase a period of time at which foodstuffs may be maintained below or at a preferred temperature by reducing effects of convective heat transfer within the air pockets and in voids between the air pockets. This reduction in the effects of this convective heat transfer reduces a speed at which the foodstuffs in a cavity of a package liner increases above a threshold temperature. For example, a threshold temperature may be selected at or near freezing to reduce the likelihood of the foodstuffs from becoming rancid, rotten, and unusable during shipping before reaching the customer (e.g., cook, baker, chef, server, restaurant, etc.) or the end user.

In the at least one embodiment of the insulating sheet material, the insulating sheet material may be a roll stock insulating sheet material with sealed edges. The roll stock insulating sheet material may be singulated or cut into individual pieces for either use in fabrication of packages, package liners, or other structures or products for insulating perishable products during a shipping process. Alternatively, the insulating sheet material may be cut and singulated into individual pieces with sealed edges of which and a plurality of these individual pieces of insulating sheet materials may be used to line a box, a crate, a package, or some other type of shipping container.

In the at least one embodiment of the insulating sheet material, the insulating sheet material may be utilized in the fabrication of a pallet wrapping that is utilized to wrap a crate on a pallet to insulate the crate during a shipping process. Alternatively, the pallet wrapping may be utilized to wrap a pallet and the crate on the pallet for insulating the crate and the pallet during a shipping process. Similarly, the pallet wrapping made from the insulating sheet material may wrap around a plurality of boxes on a pallet to hold the plurality of boxes together and insulate them during a shipping process.

In other words, the at least one embodiment of the insulating sheet material with the sealed edges may be manufactured and adjusted to be utilized in various applications to insulate a perishable product during a shipping process.

The present disclosure is directed to embodiments of methods of fabricating or manufacturing insulating materials of the present disclosure. For example, embodiments of methods of manufacturing may include all or some of the steps as follows: (1) forming a metallized polymeric layer by depositing a metallic layer on a first polymeric layer; (2) coupling a second polymeric layer to the metallized polymeric layer by coupling first ends of a layer of air pockets to the metallized polymeric layer; and (3) coupling a third polymeric layer by sealing first edges of the metallized polymeric layer to corresponding second edges of the third polymeric layer. Surrounding the second polymeric layer with the metallized polymeric layer and the third polymeric layer by sealing the first and second edges of the metallized polymeric layer to the third polymeric layer.

The polymeric layers as discussed above may be of polymer materials such as polyethylene, polyolefin, polyester, polypropylene, polyethylene, polyethylene terephthalate, or some other similar or like polymeric material or combination of polymeric materials.

Other insulating sheet materials and other package products manufactured utilizing the other insulating sheet materials include a stacked structure of various polymeric layers and layers of air pockets. At least one embodiment of one of the other insulating sheet materials may include a first layer of air pockets on a first polymeric layer, a second polymeric layer on the first layer of air pockets, a second layer of air pockets on the second polymeric layer, a third polymeric layer on the second layer of air pockets, and a metallic layer on the third polymeric layer. The second polymeric layer separates the first layer of air pockets from the second layer of air pockets. The first and second layer of air pockets are generally smaller in profile and size relative to the layer of air pockets utilized in the embodiments of the present disclosure. The first and second layers of air pockets may be formed utilizing respective polymeric layers.

The embodiments of the present disclosure of an insulating sheet material, packages, and package liners manufactured utilizing the embodiments of the insulating sheet material of the present disclosure including only one layer of air pockets cost less relative to the products manufactured utilizing the other insulating sheet material with multiple layers of air pockets. Manufacturing the embodiments with only one layer of air pockets of the present disclosure cost less as there are fewer layers of material relative to the products described above including more layers of material (e.g., multiple layers of air pockets). For example, as discussed earlier, some embodiments of the present disclosure include a stacked configuration including a first polymeric layer, a layer of air pockets on the first polymeric layer, second polymeric layer on the layer of air pockets, and a metallic layer on the first polymeric layer. The embodiments of the present disclosure including fewer layers of material relative to the layers in the other products described above including more layers of material (e.g., multiple layers of air pockets). Also, since there are fewer layers in some of the embodiments of the present disclosure, the costs of manufacturing the embodiments of the present disclosure are less than that relative to the other products described above including more layers of material (e.g., multiple layers of air pockets) as fewer steps are utilized to manufacture the embodiments of the present disclosure including a single layer of air pockets relative to the other products described above including more layers of material (e.g., multiple layers of air pockets).

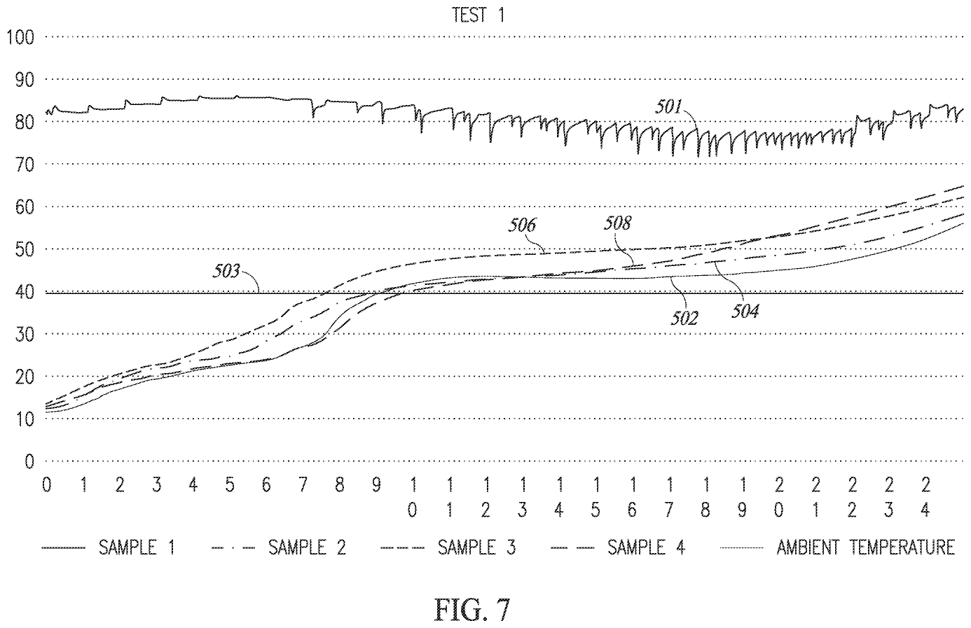

Furthermore, the layer of air pockets (e.g., bubbles) in the embodiments of the present disclosure including a single layer of air pockets are generally larger in size and profile relative to the multiple layers of air pockets other products described above manufactured utilizing the other insulating sheet materials. Generally, it is understood that smaller air pockets (e.g., bubbles) provide greater resistance against the transfer of thermal energy through an insulating sheet material or package. In other words, it is believed that smaller air pockets will keep products within a package either warmer or colder within the package for a longer period of time relative to larger air pockets. However, it will become apparent in view of the discussion of FIGS. 7, 8, and 9 that based on the testing and experiments, the embodiments of the present disclosure with the single layer of larger air pockets (e.g., bubbles) perform either substantially the same or slightly better at keeping products thermally insulated (e.g., cold or hot) within these embodiments of the present disclosure relative to the other package or package liners products described above including multiple layers of smaller air pockets.

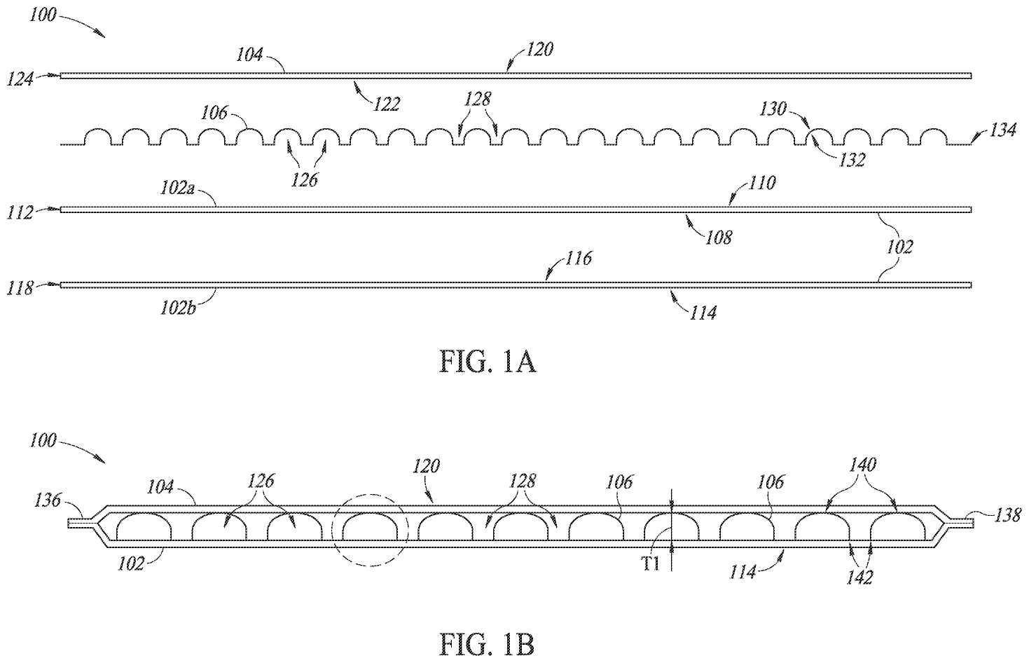

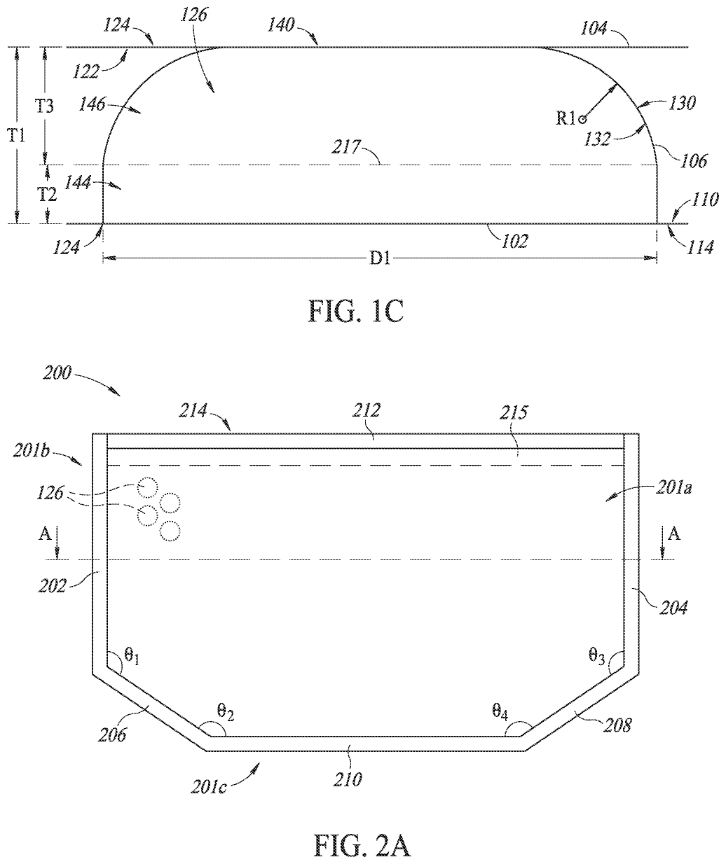

FIG. 1A is an exploded view of layers of an embodiment of an insulating sheet material 100, which may be an insulating stacked sheet material, an insulating material, or some other similar or like type of insulating sheet material including multiple polymeric (e.g., polyester, polypropylene, polyethylene, polyethylene terephthalate, etc.) layers. The insulating sheet material 100 includes a first layer 102, a second polymeric layer 104, and a third polymeric layer 106 positioned between (e.g., sandwiched between) the first layer 102 and the second polymeric layer 104. In this embodiment of the insulating sheet material 100 as shown in FIG. 1A, the second and third polymeric layers 104, 106 are polymeric layers, and the first layer 102 includes a first polymeric layer 102a and a metallic layer 102b that are stacked. The thickness of the first layer 102 may be substantially equal to 3-mil to 4-mil (e.g., 1-mil is equal to 0.001-inches). Embodiments of the present disclosure are not limited to first layer 102 of this thickness. First layer 102 can have a thickness that is less than 3 mil or a thickness that is greater than 4 mil.

For example, the first layer 102 may be a metallized polymeric layer, a metallic polymeric layer, a metal coated polymeric layer, or some other suitable type of the first polymeric layer 102a that has an outer surface 108 covered on by the metallic layer 102b.

For example, the second polymeric layer 104 may be a polymeric layer made of a polymeric material such as polyester, polypropylene, polyethylene, polyethylene terephthalate, or some other suitable polymeric material.

The first polymeric layer 102a includes the outer surface 108 and an inner surface 110 opposite to the outer surface 108. The outer surface 108 faces away from the second and third polymeric layers 104, 106 and the inner surface 110 faces towards the second and third polymeric layers 104, 106. The first polymeric layer 102a has a plurality of edges 112, which may be sidewalls or ends of the first polymeric layer 102a that extend from the outer surface 108 to the inner surface 110. The first polymeric layer 102a has a thickness extending from the first surface 108 to the second surface 110. The outer surface 108 may have a corona treatment that allows for a metallic layer 102b to be adhered and formed on the outer surface 108 of the first polymeric layer 102a.

The first, second, and third polymeric layers 102a, 104, 106 may be made of a polymeric material or a combination of polymeric materials such polyester, polypropylene, polyethylene, polyethylene terephthalate or some other suitable polymeric material or combination of polymeric materials.

The first polymeric layer 102a, the second polymeric layer 104, and the third polymeric layer 106 may each be made of multiple sub-layers of polymeric material. For example, the first, second, and third polymeric layers 102a, 104, 106 may each be made of polymeric sub-layers that are coextruded with each other at the time of forming the first, second, and third polymeric layers 102a, 104, 106. For example, each one of the first, second, and third polymeric layers 102a, 104, 106 includes a first polymeric sub-layer (e.g., outer skin layer, exterior skin layer, or external skin layer), a second polymeric sub-layer (e.g., inner skin layer, interior skin layer, or internal skin layer), and a core polymeric sub-layer (e.g., central layer) positioned between (e.g., sandwiched between) the first and second polymeric sub-layers. This multi-layer structure of the first, second, and third polymeric layers 102a, 104, 106 may be referred to as an ABA polymeric structure. After the first, second, and third polymeric layers 102a, 104, 106 are formed, the first, second, and third polymeric layers 102a, 104, 106 may be utilized to form the insulating sheet material 100 as shown in FIG. 1A.

In the preferred embodiments, the first, second, and third polymeric layers 102a, 104, 106 are each made of three polymeric sub-layers that are coupled together and stacked on each other. In some other embodiments, the first, second, and third polymeric layers 102a, 104, 106 may each be made of two polymeric sub-layers, four polymeric sub-layers, five polymeric sub-layers, or any number of polymeric sub-layers as selected at the time of co-extrusion to form each of the first, second, and third polymeric layers 102a, 104, 106. The sub-layers are generally coextruded together to form each of the first, second, and third polymeric layers 102a, 104, 106 of the insulating sheet material 100.

While in the preferred embodiment of the insulating sheet material 100 each of the first, second, and third polymeric layers 102a, 104, 106 may have three polymeric sub-layers, in some other embodiments, the first, second, and third polymeric layers 102a, 104, 106 may each have a differing number of polymeric sub-layers. For example, the first polymeric layer 102a may have three polymeric sub-layers, the second polymeric layer 104 may have four polymeric sub-layers, and the third polymeric layer 106 may have six polymeric sub-layers.

The metallic layer 102b is on and covers the first surface 108 of the first polymeric layer 102a. The metallic layer 102b may be an aluminum material, a nickel material, a chromium material, an alloy material, or some other similar or like reflective material suitable for reflecting heat and light. The metallic layer 102b includes an outer surface 114 and an inner surface 116 opposite to the outer surface 114. The outer surface 114 faces away from the second and third polymeric layers 104, 106 and the inner surface 116 faces towards the second and third polymeric layers 104, 106. The outer surface 114 may be an external, exterior, or exposed surface of the insulating sheet material 100. The metallic layer 102b has a plurality of edges 118, which may be sidewalls or ends of the metallic layer 102b that extend from the outer surface 114 to the inner surface 116. The metallic layer 102b has a thickness that extends from the outer surface 112 to the inner surface 116. In some embodiments of the present disclosure, the thickness of the metallic layer 102b is less than the thickness of the first polymeric layer 102a. For example, the metallic layer 102b may have an optical density ranging from 2.3-3.0 such that the thickness of the metallic layer 102b may be 200-Å (angstroms) to 350-Å, which is 20-nm (nanometers) to 35-nm. The preferred optical density being 2.7. Embodiments of the present disclosure are not limited to metallic layer 102b of this thickness. For example, in other embodiments, metallic layer 102b can have a thickness that is less than 200-Å (20-nm) or greater than 350-Å (35-nm). However, it will be readily appreciated that the metallic layer 102b may be made thinner or thicker than these ranges to provide optimal insulating characteristics selected on various factors to reduce the likelihood of perishable products from becoming rancid or perishing during a shipping process. In other words, the thickness of the metallic layer 102b is customizable or selectable depending on the product to be kept cold during a shipping process.

The thickness of the first polymeric layer 102a may be the difference between the total thickness of the first layer 102 and the thickness of the metallic layer 102b. However, since the metallic layer 102b is thin compared to the total thickness of the first layer 102, a thickness of the first polymeric layer 102a may be substantially equal to 3-mil to 4-mil.

The second polymeric layer 104 has an outer surface 120 and an inner surface 122 opposite to the outer surface 120. The second polymeric layer 104 has a plurality of edges 124, which may be sidewalls or ends of the second polymeric layer 104 that extend from the outer surface 120 to the inner surface 122. The second polymeric layer 104 has a thickness that extends from the outer surface 120 to the inner surface 122. The thickness of the second polymeric layer 104 may be substantially equal to 2.5-mil. Embodiments of the present disclosure are not limited to second polymeric layer 104 of this thickness. For example, in other embodiments, second polymeric layer 104 can have a thickness that is less than or greater than 2.5 mil.

The third polymeric layer 106 includes a plurality of air pockets 126, which may be a layer of bubbles or a layer of air pockets that are like or similar to a bubble wrap material. Adjacent ones of the plurality of air pockets 126 are spaced apart from each other by respective ones of a plurality of voids 128, which may be a plurality of openings, a plurality of trenches, a plurality of recesses, or some other plurality of spaces separating adjacent ones of the plurality of air pockets 126 from each other. In some embodiments, the plurality of voids 128 may be an integral, single, continuous void that extends around and between adjacent ones of the plurality of air pockets 126. The third polymeric layer 106 is positioned between (e.g., sandwiched between) the inner surface 110 of the first polymeric layer 102a of the first layer 102 and the inner surface 122 of the second polymeric layer 104. In some embodiments, the plurality of voids 128 may be individual, distinct, and separate voids. In some embodiments, the adjacent air pockets 126 of the plurality of air pockets 126 may physically abut and contact each other. The third layer includes a first surface 130 and a second surface 132 that is opposite to the first surface 130. The third polymeric layer 106 has a plurality of edges 134, which may be sidewalls or ends of the third polymeric layer 106 that extend from the first surface 130 to the second surface 132. The third polymeric layer 106 has a thickness that extends from the first surface 130 to the second surface 132. The thickness of the third polymeric layer 106 may be substantially equal to 2-mil. Embodiments of the present disclosure are not limited to third polymeric layer 106 of this thickness. For example, in other embodiments, third polymeric layer 106 can have a thickness that is less than or greater than 2-mil.

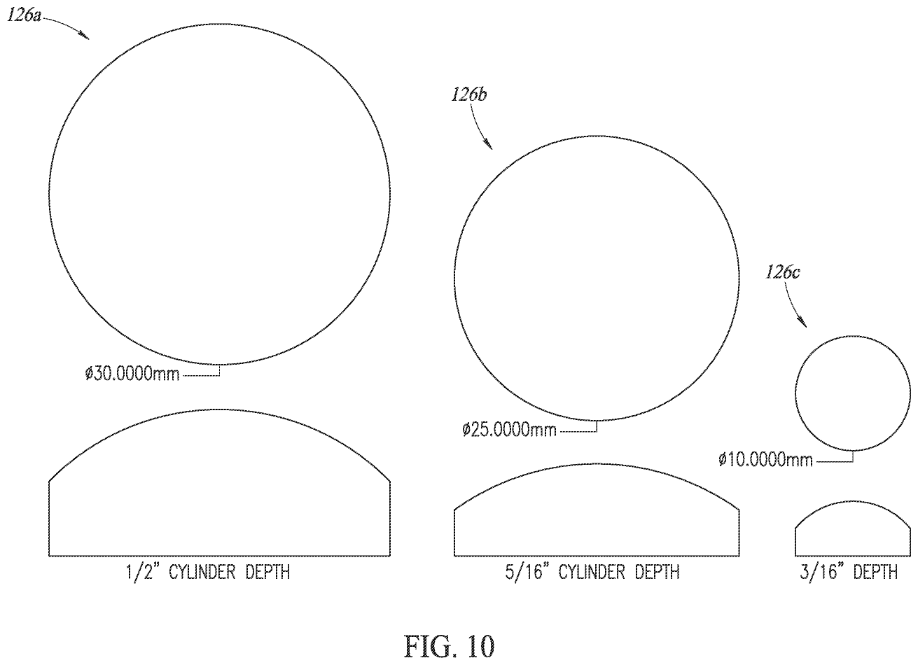

The shape and size of the air pockets may be selected from one of a first, second, and third bubble 126a, 126b, 126c as shown in FIG. 10. The preferred option being the 5/16-inch (in) bubble 126b as shown in FIG. 10.

While not shown, it will be readily appreciated that the first, second, and third polymeric layers 102a, 104, 106 and the metallic layer 102b may be reorganized in any manner to modify the insulating sheet material 100. For example, in some alternative embodiments of the insulating sheet material 100, the metallic layer 102b may be on the surface 120 of the second polymeric layer 104, or the metallic layer 102b may be on the surface 110 of the first polymeric layer 102a. In other words, the first, second, and third polymeric layers along with the metallic layer 102b may be reorganized (e.g., customizable) in any suitable manner or fashion as desired to optimize a performance of the insulating sheet material 100 under customer applications, situations, parameters, and factors.

FIG. 1B illustrates the first layer 102, the second polymeric layer 104, and the third polymeric layer 106 of the insulating sheet material 100 adhered and coupled together. The first layer 102, the second polymeric layer 104, and the third polymeric layer 106 are stacked on each other and sealed together to form the insulating sheet material 100.

As shown in FIG. 1B, the insulating sheet material 100 includes a first sealed edge 136, which is at the left-hand side of the insulating sheet material 100 based on the orientation of FIG. 1B, and a second sealed edge 138, which is at the right-hand side of the insulating sheet material 100 based on the orientation of FIG. 1B. The first and second sealed edges 136, 138 may be heat sealed together. At the first and second sealed edges 136, 138, corresponding ones of the edges 112, 124, 134 have been melted together sealing the corresponding ones of the edges 112, 124, 134 together. The formation of the first and second edges 136, 138 will be discussed in further detail later on within the present disclosure with respect to FIG. 4 of the present disclosure.

In this embodiment of the insulating sheet material 100 as shown in FIGS. 1A-1B, the edges 134 of the third polymeric layer 106 may have deflated or compressed air pockets (not shown), which have been crushed and popped, that are substantially flat relative to the air pockets 126 of the third polymeric layer 106 that are inflated. These deflated and crushed air pockets at the edges 134 of the third polymeric layer 106 are present at the first and second sealed edges 136, 138 of the insulating sheet material 136, 138.

In some other embodiments of the insulating sheet material 100, the edges 134 of the third polymeric layer 106 may not have any deflated air pockets present, and, instead, the edges 134 may only be a flat polymeric material like or similar to the first polymeric layer 102a and the second (polymeric) layer 104.

In yet some other embodiments of the insulating sheet material 100, the edges 134 of the third polymeric layer 106 may not be present at all such that the third polymeric layer 106 is not present at the first and second sealed edges 136, 138 altogether. Instead, in these other embodiments, the edges 112 of the first polymeric layer 102a are directly sealed together with corresponding ones of the edges 124 of the second polymeric layer 104.

As can be readily seen in FIG. 1B, the plurality of air pockets 126 have first ends 140 and second ends 142 opposite to the first ends 140. The first ends 140 are coupled to the second polymeric layer 104 and the second ends 142 are coupled to the first layer 102. For example, the second ends 142 may be heat sealed to the inner surface 122 of the second polymeric layer 104, and the first ends 140 may be heat sealed to inner surface 110 of the first polymeric layer 102a of the first layer 102. Ones of the plurality of air pockets 126 include a thickness T1, which may be 0.29-inches (in). The thickness T1 extends between a respective first end 140 of one of the plurality of air pockets 126 to a respective second end 142 of the one of the plurality of air pockets 126.

The insulating sheet material 100 may be a smaller portion of a larger continuous and unitary insulating sheet material with various sections that are compressed, crushed, and heat sealed sections that are the same or similar to the sealed edges 136, 138 of the insulating sheet material 100. For example, the sealed edges 136, 138 may extend to adjacent layers of air pockets the same or similar to the plurality of air pockets 126 as shown in FIG. 1B. The insulating sheet material 100 may then be formed utilizing the larger continuous and unitary insulating sheet material by singulating the larger insulating sheet material into smaller portions such as the insulating sheet material 100 as shown in FIG. 1B.

In an alternative embodiment of the insulating sheet material 100, the insulating sheet material 100 may further include the layer of air pockets 126 as well as a second layer of air pockets stacked on the first layer of air pockets. The second layer of air pockets are separated from the first layer of air pockets by an additional polyethylene layer to which the first ends 140 of the first layer of air pockets are separated from ends of the second layer of air pockets similar to the second ends 142 of the first layer of air pockets.

FIG. 1C illustrates a zoomed-in enhanced view of an encircled bubble or air-pocket 126 as shown and depicted in FIG. 1B. For the sake of simplicity and brevity of the present disclosure, the details of only a single air pocket 126 will be discussed in further detail. However, while only additional details will be discussed with respect to the single air pocket 126 as shown in FIG. 1C, it will be readily appreciated that the following discussion of the single air pocket 126 applies to other ones of the plurality of air pockets 126 as shown in FIGS. 1A and 1B.

A structure of the single air pocket 126 as shown in FIG. 1C may be over-exaggerated to depict, show, or represent certain features of the single air pocket 126. For example, a radius R1 of a curved portion of the bubble may be significantly smaller than as shown in FIG. 1C. However, for ease of understanding, the radius of curvature has been over-exaggerated in size and shape to assist in one understanding of the overall shape and size of the single air pocket 126. Similarly, a thickness T3 as shown in FIG. 1C may be significantly smaller than as shown in FIG. 1C as the radius R1 has been over-exaggerated. In other words, this over-exaggeration in the radius R1 has caused the thickness T3 being over-exaggerated in FIG. 1C as well. In other words, the overall shape of the single air pocket 126 as shown in FIG. 1C has been provided to represent the overall profile of the single air pocket 126.

The air pocket 126 includes a first portion 144 and a second portion 146 adjacent to the first portion 144 such that the second portion 146 is stacked on the first portion 144 based on the orientation of the air pocket 126 as shown in FIG. 1C.

The first portion 144 is substantially cylindrical in shape having a diameter D1 as shown in FIG. 1C. The diameter D1 may be 0.984-inches (in). The diameter D1 is a maximum diameter of the air pocket 126 a diameter of the second portion 146 gradually decreases as the air pocket 126 extends towards the second polymeric layer 104 as the second portion 146 is a rounded shape that is overlying the first portion 144. The first portion 144 further includes a thickness T2 transverse (e.g., substantially perpendicular) to the inner surface 110 of the first polymeric layer 102a of the first layer 102. The thickness T2 extends from the inner surface 110 of the first polymeric layer 102a of the first layer 102 to the second portion 146.

The second portion 146 with the rounded shape may be a semi-hemispherical shape in which the top of the hemisphere has a blunt or flat surface, which is readily apparent in view of FIG. 1C. The rounded shape of the second portion 146 has the radius R1, which is a radius of curvature of rounded surfaces of the second portion 146 of the air pocket 126.

The second portion 146 further includes a thickness T3 transverse (e.g., substantially perpendicular) to the inner surface 110 of the first polymeric layer 102a of the first layer 102. The thickness T3 extends from the inner surface 132 of the third polymeric layer 106 at the first end 140 of the air pocket 126 to the first portion 144 of the air pocket 126. The dotted horizontal line in FIG. 1C represents a plane in which the rounded shape and the cylindrical shape come together. In this embodiment, the thickness T3 of the bubble 126 is greater than the thickness T2 of the bubble 126. In some embodiments, the thickness T3 of the bubble 126 may be less than the thickness T2 of the bubble 126. In some embodiments, the thickness T3 of the bubble 126 may be substantially equal to the thickness T1 of the bubble 126.

While in the description above of the sealed edges 136, 138 of the embodiment of the insulating sheet material 100 as shown in FIGS. 1A-1C are described as being heat sealed. In some alternative embodiments of the insulating sheet material 100, the sealed edges 136, 138 may instead be sealed together by a tape, an adhesive, or some other like or similar technique for forming the sealed edges 136, 138 of the insulating sheet material 100. For example, when the tape is utilized to form the sealed edges 136, 138, the tape wraps around the edges 112, 118, 124, 134 of the respective layers 102a, 102b, 104, 106 of the insulating sheet material 100 to form the sealed edges 136, 138 of the insulating sheet material 100. Alternatively, when the adhesive is utilized, the adhesive may be formed around, between, or on the edges 112, 118, 124, 134 and the respective layers 102a, 102b, 104, 106 to form the sealed edges 136, 138 of the insulating sheet material 100. In some other alternative embodiments, multiple pieces of tape may be utilized such that the pieces of the tape partially overlap each other to form the sealed edges 136, 138 between the edges 112, 118, 124, 134 of the respective layers 102a, 102b, 104, 106 of the insulating sheet material 100.

In some other alternative embodiments, the sealed edges 136, 138 of the insulating sheet material 100 may be formed by utilizing a combination of tape, adhesive, heat seals, or some other type of like or suitable combination of techniques for forming the sealed edges 136, 138 of the insulating sheet material 100. For example, each of the sealed edges 136, 138 may be formed by both the adhesive and the tape techniques, by both the tape and heat sealing techniques, or by another combination of sealing techniques. Alternatively, the first sealed edge 136 may be formed by the tape whereas the second sealed edge 138 may be formed by heat sealing, or some other combination of techniques may be utilized to form the sealed edges 136, 138.

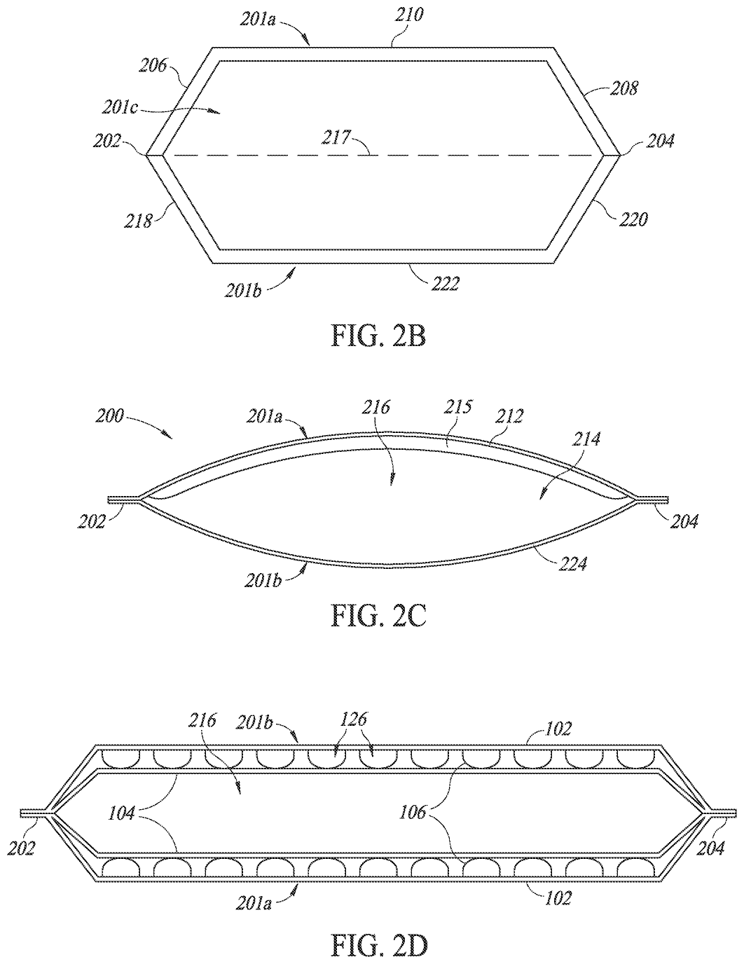

FIG. 2A illustrates a package liner 200 structured to be utilized in a cold chain application for shipping foodstuffs to a customer or an end user that may reduce the likelihood of food becoming rancid, rotten, or uneatable upon receipt by the customer or the end user. The package liner 200 is formed utilizing the insulating sheet material 100 as discussed earlier in FIGS. 1A-1C. However, for the sake of simplicity and brevity of the present disclosure, the details of manufacturing the package liner 200 will be discussed in further detail later with respect to FIG. 6 of the present disclosure.

The dimensionality, size, and shape of embodiments of package liners and packages of the present disclosure may readily be adjusted, customized, or selected based on factors such as a temperature at which a product is to be kept, a size and shape of the product, a size and shape or a shipping container, a distance the product will travel, or some other factors. At least one embodiment of the package liner 200 has been shown in FIG. 2A-2D. The package liner 200 includes a first insulating sheet material 201a, a second insulating sheet material 201b, and a third insulating sheet material 201c. The first insulating sheet material 201a is at a front of the package liner 200 as shown in FIG. 2A, the second insulating sheet material 201b is at a rear of the package liner 200 as shown in FIGS. 2B and 2C, and the third insulating sheet material 201c is at a bottom side of the package liner 200 as shown in FIGS. 2B and 2C. The first, second, and third insulating sheet materials 201a, 201b, 201c are the same or similar to the insulating sheet material 100 as shown and described earlier with respect to FIGS. 1A-1C. Accordingly, for the sake of simplicity and brevity of the present disclosure, the details of the features of the first, second, and third insulating sheet materials 201a, 201b, 201c will not be discussed in further detail herein.

The package liner 200 includes a first sealed edge 202, a second sealed edge 204, a third sealed edge 206, a fourth sealed edge 208, a fifth sealed edge 210, and a sixth sealed edge 212. The first sealed edge 202 is at the left-hand side of the package liner 200 based on the orientation in FIG. 2A, and the second sealed edge 204 is at the right-hand side of the package liner 200 based on the orientation in FIG. 2A. The first sealed edge 202 is opposite to the second sealed edge 204. The third sealed edge 206 is at the left-hand side of the package liner 200 based on the orientation in FIG. 2A, and the fourth sealed edge 208 is at the right-hand side of the package liner 200 based on the orientation in FIG. 2A. The third sealed edge 206 is opposite to the fourth sealed edge 208. The fifth sealed edge 210 is at a bottom side of the package liner 200 and the sixth sealed edge 212 is at a top side of the package liner 200. The fifth sealed edge 210 is opposite to the sixth sealed edge 212.

The third sealed edge 206 is transverse to the first and fifth sealed edges 202, 210, respectively, and extends from the first sealed edge 202 to the fifth sealed edge 210. The third sealed edge 206 is transverse to the first sealed edge 202 by a first angle θ1, and the third sealed edge 206 is transverse to the fifth sealed edge 210 by a second angle θ2.

The fourth sealed edge is transverse to the second and fifth sealed edges 204, 210, respectively, and extends from the second sealed edge 204 to the fifth sealed edge 210. The fourth sealed edge 208 is transverse to the second sealed edge by a third angle θ3, and the fourth sealed edge 208 is transverse to the fifth sealed edge 210 by a fourth angle θ4.

The fifth sealed edge 210 extends from the third sealed edge 206 to the fourth sealed edge 208. In this embodiment, the fifth sealed edge 210 is less wide than the sixth sealed edge 212, which is readily apparent in FIG. 2A.

The sixth sealed edge 212 extends from the first sealed edge 202 to the second sealed edge 204. The sixth sealed edge 212 is directly adjacent to an opening 214 of the package liner 200 that is at the top side of the package liner 200 providing access to a cavity 216 within the package liner 200. The opening 214 and the cavity 216 are readily seen in the top plan view of the package liner as shown in FIG. 2C.

The first, second, third, fourth, and fifth sealed edges 202, 204, 206, 208, 210 have a first thickness that is greater than a second thickness of the sixth sealed edge 212. The first, second, third, fourth, and fifth sealed edges 202, 204, 206, 208, 210 are sealed edges of the at least three insulating sheet materials 201a, 201b, 201c that are sealed together. However, unlike the first, second, third, fourth, and fifth sealed edges 202, 204, 206, 208, 210, the sixth sealed edge 212 is a single sealed edge of a single insulation material sheet similar to the edges 136, 138 of the insulating sheet material 100 as shown in FIG. 1C. Instead, the sixth sealed edge 212 has a second thickness that is less than the first thickness of the first, second, third, fourth, and fifth sealed edges.

The first thickness of the first and second edges 202, 204 is greater than the second thickness of the sixth sealed edge 212 as the first and second sealed edges 202, 204 are sealed edges between the first insulating sheet material 201a and the second insulating sheet material 201b. For example, the first and second sealed edges 202, 204 are a stacked combination of respective first layers 102, respective second layers 104, and respective third polymeric layers 106 of the first and second insulating layers 201a, 201b, which may be insulating sheets, insulating sheet layers, insulating sheet materials, or some other suitable type of insulating material. In this embodiment of the package liner 200, at the first and second sealed edges 202, 204, the respective second layers 104 and the respective third polymeric layers 106 are heat sealed together. In some other embodiments, the respective third polymeric layers 106 are not present at the first and second sealed edges 202 such that the respective second layers 104 of the first and second insulating sheet materials 201a, 201b are directly heat sealed together.

The first thickness of the third, fourth, and fifth sealed edges 206, 208, 210 is greater than the second thickness of the sixth sealed edge 212 as the third, fourth, and fifth sealed edges 206, 208, 210 are sealed edges between the first insulating sheet material 201a and the third insulating sheet material 201c. For example, the third, fourth, and fifth sealed edges 206, 208, 210 are a stacked combination of respective first layers 102, respective second layers 104, and respective third polymeric layers 106 of the first and third insulating layers 201a, 201c. In this embodiment of the package liner 200, at the third, fourth, and fifth sealed edges 206, 208, 210, the respective second layers 104 and the respective third polymeric layers 106 are heat sealed together. In some other embodiments, the respective third polymeric layers 106 are not present at the third, fourth, and fifth sealed edges 206, 208, 210 such that the respective second layers 104 of the first and second insulating sheet materials 201a, 201b are directly heat sealed together.

The sixth sealed edge 212 is less thick than the first, second, third, fourth, and fifth sealed edges 202, 204, 206, 208, 210. The at least three insulating sheet materials 201a, 201b, 201c (e.g., front side, rear side, and bottom side insulating sheet materials 201a, 201b, 20c) utilized to form the package liner 200 are not sealed together at the top side of the package liner 200 as the opening 214 is present. Instead, the sixth sealed edge 212 is the same or similar to the sealed edges 136, 138 as described and shown in FIG. 1B. Accordingly, the sixth sealed edge 212 is less thick than the first, second, third, fourth, and fifth sealed edges 202, 204, 206, 208, 210. In other words, unlike the sixth sealed edge 212, he first, second, third, fourth, and fifth sealed edges 202, 204, 206, 208, 210 are seals either between the first insulating sheet material 201a and the second insulating sheet material 201b or between the first insulating sheet material 201a and the third insulating sheet material 201c.

The opening 214 in the package liner 200 allows for foodstuffs or products to be placed within the cavity 216 of the package liner 200. The opening 214 and the cavity 216 is readily seen in FIG. 2D of the present disclosure.

An adhesive 215 is present at an interior surface of the first insulating sheet material 201a. The adhesive 215 may be covered by a strip (e.g., release liner that may be made of paper, plastic, or some other material) that is removed (e.g., pulled off) allowing a user to seal the package liner 200 using the adhesive 215 to close the opening 214 and seal the cavity 216 during shipping. In other words, the adhesive 215 allows for the package liner to be sealed once a product or foodstuffs has been positioned within the package liner 200 for shipping to keep the product or foodstuffs within the package liner 200 cold during the shipping process.

In some embodiments, the adhesive 215 may be present on an exterior or outer surface of the first insulating sheet material 201a. The exterior or outer surface being opposite to the interior surface of the insulating sheet material 201a.

In some embodiments, the adhesive 215 may be replaced by a double-sided tape with one side of the double-sided tape adhered to an interior or exterior surface of the first insulating sheet material 201a and the other side being covered by a release liner. When the release liner is removed (e.g., pulled off), the other side of the double-sided tape is exposed and is adhered to another surface of the package liner 200 to close off the opening 214 and seal the cavity 216 of the package liner 200. FIG. 2B illustrates a bottom view of the package liner 200 as shown in FIG. 2A. The package liner 200 further includes a seventh sealed edge 218, an eighth sealed edge 220 opposite to the seventh sealed edge 218, and a ninth sealed edge 222 extending from the seventh sealed edge 218 to the eighth sealed edge 220. The seventh sealed edge 218 is at the left-hand side of the package liner 200 based on the orientation in FIG. 2B, and the eighth sealed edge 220 is at the right-hand side of the package liner 200 based on the orientation in FIG. 2B. The ninth sealed edge 222 is at a rear of the package liner 200. The rear is opposite to the front of the package liner 200. The ninth sealed edge 222 is at the bottom side of the package liner 200.

The seventh sealed edge 218 extends from the first sealed edge 202 to the ninth sealed edge 222. The seventh sealed edge 218 is transverse to the first sealed edge 202 and is at an angle (not shown) relative to the first sealed edge 202 that may be the same or similar to the first angle θ1 as described earlier within the present disclosure. The seventh sealed edge 218 is transverse to the ninth sealed edge 222 by an angle (not shown) relative to the ninth sealed edge 222 that may be the same or similar to the second angle θ2 as described earlier within the present disclosure. The seventh sealed edge 218 has a thickness similar to the thickness of the third sealed edge 206.

The eighth sealed edge 220 extends from the second sealed edge 204 to the ninth sealed edge 222. The eighth sealed edge is transverse to the second sealed edge 204 by an angle relative to the second sealed edge 204 that may be the same or similar to the third angle θ3 as described earlier within the present disclosure. The eighth sealed edge 220 is transverse to the ninth sealed edge 222 by an angle relative to the ninth sealed edge 222 that may be the same or similar to the fourth angle θ4 as described earlier within the present disclosure. The eighth sealed edge 220 has a thickness similar to the thickness of the fourth sealed edge 208.

Although a rear view of the package liner 200 is not shown in the present disclosure, it will be readily appreciated that the second insulating sheet material 201b will be the same or similar to the first insulating sheet material 201a. For example, the first insulating sheet material 201a has a shirt-pocket like shape as can be readily seen in FIG. 2A, and the second insulating sheet material 201b has the shirt-pocket like shape as well.

A crease 217 extends from the first sealed edge 202 to the second sealed edge 204. The crease 217 is configured to allow for the package liner 200 to be opened up such that the package liner 200 will fill a space within a box (not shown) such that the package liner 200 lines the box. The crease 217 is configured to allow for the package liner 200 to be folded flat for shipment to a customer within a shipment container, and the package liner 200 is later expanded to be utilized to ship foodstuffs or products to a customer.

The crease line 217 with the fifth and ninth sealed edges 210, 222 as shown in FIGS. 2A and 2B, form or provide an inverted V-shape when the package liner 200 is flat. The inverted V-shape of the package liner 200 may be opened up and expanded when utilizing the package liner 200 to line a box or a shipping container such that the package liner 200 may mimic the internal shape of the shipping container. The expansion of the inverted V-shape may readily be seen in FIG. 2B.

In at least one alternative embodiment of the package liner 200, the fifth sealed edge 210 and the ninth sealed edge 222 may not be present as the first, second, and third insulating sheet materials 201a, 201b, 201c may be replaced by a single, unitary, and continuous insulating sheet material. In other words, the first, second, and third insulating sheet materials 201a, 201b, 201c may be integral with each other such that the first, second, and third insulating sheets 201a, 201b, 201c are the single, unitary, and continuous insulating sheet material. In this at least one alternative embodiment, the single, continuous insulating sheet material is instead folded at locations corresponding to the fifth and ninth sealed edges 210, 222 as shown in FIGS. 2A and 2B. In other words, the single, continuous insulating sheet material is folded at these locations and then sealed at the first, second, third, fourth, seventh and eighth sealed edges 202, 204, 206, 208, 218, 220. Sealing and folding the single, continuous insulating sheet material in this manner forms the opening 214 and the cavity 216 of this at least one alternative embodiment of the package liner 200. The folds that replace the fifth and ninth sealed edges 210, 222 as shown in FIGS. 2A and 2B, the folds form or provide an inverted V-shape when the package liner 200 is flat. The inverted V-shape of the package liner 200 may be opened up and expanded when utilizing the package liner 200 to line a box or a shipping container such that the package liner 200 may mimic the internal shape of the shipping container.

FIG. 2C illustrates to a top plan view of the package liner 200. The opening 214 and the cavity 216 are readily viewable in the top plan view as illustrated in FIG. 2C. The opening 214 providing access to the cavity 216, and the cavity 216 storing foodstuffs or product within the package liner 200 was described earlier within the present disclosure. Accordingly, for the sake of simplicity and brevity of the present disclosure, the functionality of the opening 214 and the cavity 216 will not be reproduced here within the present disclosure.

The package liner 200 further includes a tenth sealed edge 224, which is at the top of the package liner 200. The tenth sealed edge 224 is opposite to the sixth sealed edge 212 as the tenth sealed edge 224 is an edge of the second (e.g., rear) insulating sheet material 201b, whereas the sixth sealed edge 212 is an edge of the first (e.g., front) insulating sheet material 201a. In this embodiment, the tenth sealed edge 224 is wider than the fifth sealed edge 210 and the ninth sealed edge 222, which is readily apparent in FIG. 2A. The ninth sealed edge 222 has a thickness similar to the thickness of the fifth sealed edge 210.

The tenth sealed edge 224 extends from the first sealed edge 202 to the second sealed edge 204. The tenth sealed edge 224 is directly adjacent to the opening 214 of the package liner 200 that is at the top side of the package liner 200 providing access to the cavity 216 within the package liner 200. The tenth sealed edge 224 has a similar thickness as the sixth sealed edge 212, which is less than the thicknesses of the first, second, third, fourth, fifth, seventh, eighth, and ninth sealed edges 202, 204, 206, 208, 210, 218, 220, 222.

The sealed edges 202, 204, 206, 208, 210, 212, 218, 220, 222, 224 may be heat sealed edges. The formation of the sealed edges 202, 204, 206, 208, 210, 212, 218, 220, 222, 224 will be discussed in further detail with respect to FIG. 6.

In some embodiments, the sixth sealed edge 212 and the tenth sealed edge 224 may not be present such that the edges adjacent to the opening 214 are simply raw-cut edges. In other words, the edges adjacent to the opening 214 are not sealed edges. However, the opening 214 may still be sealed or closed off by utilizing the adhesive 215 as discussed earlier within the present disclosure.

FIG. 2D illustrates a cross-sectional view taken along line A-A of FIG. 2A in which the first and second sealed edges 202, 204 of the first and second insulating sheet materials 201a, 201b at which the first and second insulating sheet materials are sealed together.

While in the description above of the sealed edges 202, 204, 206, 208, 210, 218, 220, 222 of the embodiment of the package liner 200 are described as being heat sealed. In some alternative embodiments of the package liner 200, the sealed edges 202, 204, 206, 208, 210, 218, 220, 222 may instead be sealed together by a tape, an adhesive, or some other like or similar technique for forming the sealed edges 202, 204, 206, 208, 210, 218, 220, 222 between the respective edges of the first, second, and third insulating sheet materials 201a, 201b, 201c. For example, when the tape is utilized to form the sealed edges 202, 204, 206, 208, 210, 218, 220, 222, the tape wraps around the respective edges of the first, second, and third insulating sheet materials 201a, 201b, 201c to form the sealed edges 202, 204, 206, 208, 210, 218, 220, 222. Alternatively, when the adhesive is utilized to from the sealed edges 202, 204, 206, 208, 210, 218, 220, 222, the adhesive may be formed around, between, or on the respective edges of the first, second, and third insulating sheet materials 201, 201b, 201c to form the sealed edges 202, 204, 206, 208, 210, 218, 220, 222. In some other alternative embodiments, multiple pieces of tape may be utilized such that the pieces of tape partially overlap each other to form the sealed edges 202, 204, 206, 208, 210, 218, 220, 222 between the respective edges of the first, second, and third insulating sheet materials 201a, 201b, 201c.

In some other alternative embodiments, the sealed edges 202, 204, 206, 208, 210, 218, 220, 222 of the first, second, and third insulating sheet materials 201a, 201b, 201c may be formed by utilizing a combination of tape, adhesive, heat seals, or some other type of like or suitable technique for forming the sealed edges 202, 204, 206, 208, 210, 218, 220, 222 between the first, second, and third insulating sheet materials 201a, 201b, 201c. For example, each of the sealed edges 202, 204, 206, 208, 210, 218, 220, 222 may be formed by both the adhesive and the tape techniques, by both the tape and heat sealing techniques, or by another combination of sealing techniques. Alternatively, some of the sealed edges 202, 204, 206, 208, 210, 218, 220, 222 may be formed by the tape whereas others of the sealed edges 202, 204, 206, 208, 210, 218, 220, 222 may be formed by heat sealing, or some other combination of techniques may be utilized to form the sealed edges 202, 204, 206, 208, 210, 218, 220, 222.

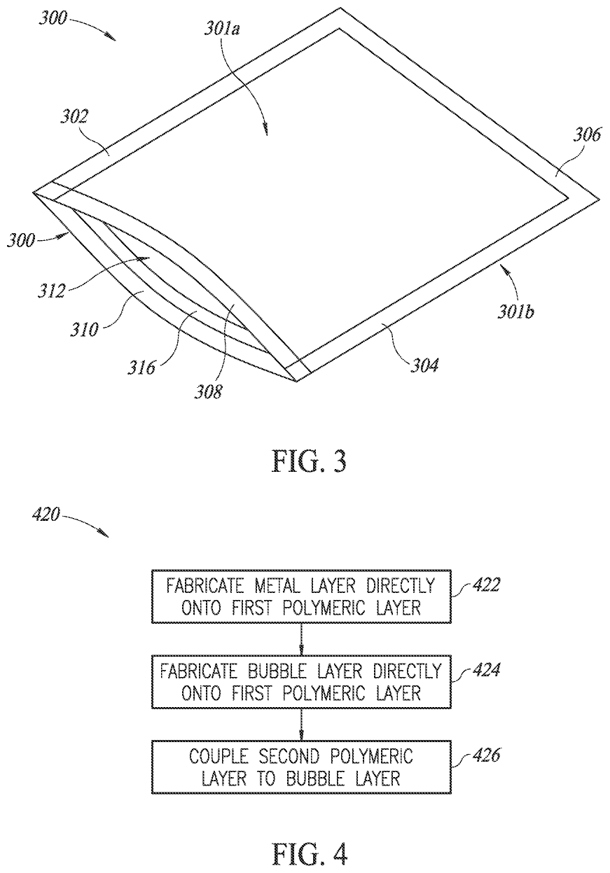

It will be readily appreciated that similar techniques may be utilized to form sealed edges 302, 306, 308, 310 of a package 300 as shown in FIG. 3. Accordingly, for the sake of simplicity and brevity of the present disclosure, the discussion of these various sealing techniques will not be discussed with respect to the package 300 as shown in FIG. 3 as follows.

FIG. 3 illustrates a perspective view of a package 300 formed of a first and second insulating sheet materials 301a, 301b coupled and sealed together. Unlike the package liner 200 that includes at least three insulating sheet materials 201a, 201b, 201c, the package 300 has only two insulating sheet materials 301a, 301b. The first and second insulating sheet materials 301a, 301b are the same or similar to the insulating sheet materials 100, 201a, 201b, 201c as shown and described earlier with respect to FIGS. 1A-1C and 2A-2D. Accordingly, for the sake of simplicity and brevity of the present disclosure, the details of the first and second insulating sheet materials 301a, 301b of the package 300 will be readily apparent and the discussion with respect to the details of the insulating sheet materials 301a, 301b will not be discussed in further detail herein.

The package 300 includes a first sealed edge 302, a second sealed edge 304, a third sealed edge 306, a fourth sealed edge 308, and a fifth sealed edge 310. The package 300 further includes a cavity 312, an opening 314 providing access to the cavity, and an adhesive 316 on an interior surface of the second insulating sheet material 301b.

The first, second, third sealed edges 302, 304, 306 are the same or similar to the sealed edges 202, 204, 206, 208, 210, 218, 220, 222 as described earlier within the present disclosure. Accordingly, for the sake of simplicity and brevity of the present disclosure, the details of the first, second, and third sealed edges 302, 304, 306 will be readily apparent and the discussion with respect to the details of the first, second, and third sealed edges 302, 304, 306 will not discussed in further detail herein.

In the above package liner 200 and the package 300, the metallic layer 102b may be at an exterior surface of the package liner 200 and the package 300. In alternative embodiments, the metallic layer 102b may be at an interior surface of the package liner and the package 300 such that the metallic layer is within the cavity 216 of the package liner 200 or the cavity 312 of the package 300, respectively. When the metallic layer 102b is at the interior surface of the package liner 200 or the package 300, the metallic layers 102b of the insulating sheets 201a, 201b, 301a, 301b of the package liner 200 and the package 300 may be sealed together at sealed edges 202, 204, 206, 208, 210, 212, 218, 220, 222, 302, 304, 306, 308, 310, respectively.

FIG. 4 is directed to a method of manufacturing 420 the insulating sheet material 100 as shown in FIGS. 1A-1C. As shown in FIG. 4, the method 420 includes fabricating the metallic layer 102b directly onto the outer surface 108 of the first polymeric layer 102a through any suitable metallizing process at step 422. For example, the metallic layer 102b may be formed on the first polymeric layer 102a by a vapor deposition process. In this vapor deposition process, the metallic layer 102b is formed by coating processes in which metal materials are in a vapor state that are condensed through condensation, chemical reaction, or conversion to deposit the metallic layer 102b onto different substrates (e.g., polymeric layer). Types of vapor deposition techniques include physical vapor deposition (PVD) and chemical vapor deposition (CVD) methods. The PVD process is a vaporization process through which atom-by-atom or molecule-by molecule transfer of a metal material occurs from the solid phase to the vapor phase resulting in deposition of the metallic layer 102b on the first polymeric layer 102a. The CVD process utilizes a chemical reaction forming a coating from a vapor, with the reaction by-products leaving as volatile species causing the metallic layer 102b to be coated on the first polymeric layer 102a.

When the metallic layer 102b is formed by the vapor deposition process, the metallic layer 102b may be a metallic film, a metallized film, a conductive material film, or some other similar or like film on the first polymeric layer 102a.

In an alternative embodiment, the metallic layer 102b may be formed by a lamination process in which the metallic layer 102b is laminated onto the first polymeric layer 102a. For example, in this lamination process, the metallic layer 102b is a sheet roll material of the metallic layer 102b that is rolled onto the first polymeric layer 102a with a heated roller and is coupled to the first polymeric layer 102a through the use of the heated roller. The heated roller applies enough heat to the metallic layer adhering the metallic layer 102b to the first polymeric layer. In an alternative embodiment of the lamination process, the metallic layer 102a may be coupled to the first polymeric layer 102b by an adhesive placed on the first polymeric layer 102b upon which the metallic layer 102a is rolled onto by a roller.

In comparison, particles of the metallic layer 102b when formed utilizing the vapor deposition process are smaller as compared to the particles of the metallic layer 102b formed by the lamination process. The smaller particles of the metallic layer 102b formed by the vapor deposition process are generally preferred for recyclability purposes over the larger particles of the metallic layer 102b formed by the lamination process. The smaller particles are preferred as the smaller particles result in less contaminants within recycled materials formed during recycling processes. Furthermore, when breaking down (e.g., recycling) the metallic layer 102b formed by the vapor deposition process and the first polymeric layer 102a, the smaller particles of the metallic layer 102b formed by the vapor deposition process may pass through a netting, a screen net, or a screen mesh whereas particles of the polymeric layer 102b may not pass through the netting, the screen net, or the screen mesh during a recycling process. Alternatively, when breaking down (e.g., recycling) the metallic layer 102b and the first polymeric layer 102a by the lamination process and the first polymeric layer 102a, the larger particles of the metallic layer 102b formed by the lamination process may not pass through the netting, the screen net, or the screen mesh resulting in the recycled material being contaminated by the larger particles that do not pass through the netting, the screen net, or the screen mesh during the recycling process.

The method 420 also includes coupling or fabricating the third polymeric layer 106 directly onto the second surface 154 of the first polymeric layer 102a, such as through any suitable process for forming cellular cushioning materials, at step 424. In some cases, such a process of fabricating the third polymeric layer 106 can include starting with a flat or planar polymeric layer and forming the bubbles of the third polymeric layer 106 as the third polymeric layer 106 is coupled to the first polymeric layer 102a. In such cases, the third polymeric layer 106 as it is illustrated in FIG. 3 represents the third polymeric layer 106 after such a process has occurred. In some other embodiments, the bubbles 126 may be formed in the third polymeric layer 106, and then the third polymeric layer 106 is coupled to the inner surface 110 of the first polymeric layer 102a.

The metallic layer 102b can be fabricated directly onto the outer surface 108 of the first polymeric layer 102a at step 422 either before or after the third polymeric layer 106 is fabricated directly onto the inner surface 110 of the first polymeric layer 102a at step 424. The method 420 also includes coupling the second layer 104 to the third polymeric layer 106, such as by using a heat gun or other source of heat to melt the respective materials and weld them together, at 426. Similarly, in step 424, the third polymeric layer 106 may be coupled to the first polymeric layer 102a by using a heat gun or other source of heat to melt the respective materials and weld them together.

Once fabricated according to the method 420, as described above, the packaging material 130 forms a metallized cellular cushioning material. The insulating sheet material 100, which may be a cellular cushioning material has a plurality of spaced apart air-filled or other gas-filled hemispherical or dome-shaped air pockets 126, which may be bubbles, formed from the third polymeric layer 106 that protrude outward away from the flat or planar first polymeric layer 102a. The air pockets 126 of the insulating sheet material can be spaced apart from one another in a regular pattern, such as in a triangular, square, or hexagonal tiling pattern, or in an irregular pattern. The air pockets 126 of the insulating sheet material 100 can have various shapes when viewed from above (e.g., along a minor axis of the cellular cushioning material), such as circular, hexagonal, square, or triangular shapes, and can have any suitable size. In other words, the air pockets 126 may be triangular in shape, circular in shape, cylindrical in shape, hexagonal in shape, square in shape, triangular in shape, or may be some other polygonal shape.

The metallic layer 102b can comprise any suitable metallic material, including aluminum, nickel, or chromium. The first, second, and third polymeric layers 102a, 104, 106 can comprise any suitable polymeric material, including polyester, polypropylene, or polyethylene terephthalate. In some specific implementations, the metallic layer 102b can comprise an aluminum material and the first, second, and third polymeric layers 102a, 104, 106 can each comprise a polyethylene material, such as a high-density polyethylene and linear low-density polyethylene co-extrusion.

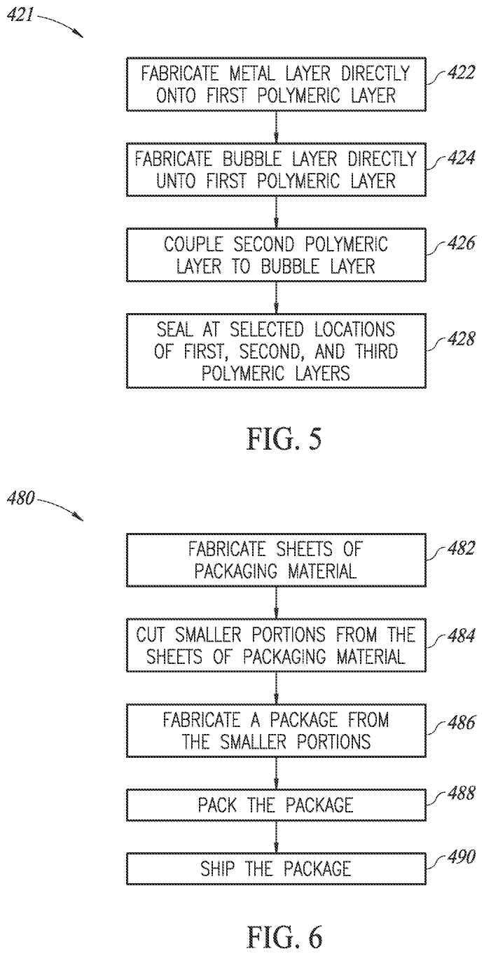

FIG. 5 illustrates a method of manufacturing 421 the sealed edges 136 of the insulating sheet material 100 as in step 428. The sealed edges 136 may be formed by compressing and applying a heat at the locations of the insulating sheet material 100 corresponding to the edges 112, 124, 134, respectively, of the first polymeric layer 102a, the second layer 104, and the third polymeric layer 106 as shown in FIGS. 1A-1C. By compressing and heating these locations corresponding to the edges 112, 124, 134, the first, second, and third polymeric layers 102a, 104, and 106 are melted together bonding the first, second, and third polymeric layers 102a, 104, 106 together at these locations. After the first, second, and third polymeric layers 102a, 104, 106 are bonded together, the insulating sheet material 100 is singulated or cut to form individual portions of the insulating sheet material 100. The individual portions of the insulating sheet material 100 are then utilized to form the package liner 200 or the package 100. For example, the individual portion of the insulating sheet material 100 may be the insulating sheet materials 201a, 201b, 201c, 301a, 301b of the package liner 200 and the package 300, respectively.

In some embodiments, when the edges 134 of the third polymeric layer 106 are not present at these locations, only the first and second polymeric layers 102a, 104 may be melted together at locations corresponding to the edges 112, 124 of the first and second polymeric layers 104, 102a.

FIG. 6 illustrates a method 480 of fabricating and using the package liner 200 or the package 300 with one or more of the insulating sheet materials 100, 201a, 201b, 201c, 301a, 301b as described herein within the present disclosure. The method 480 includes fabricating one or more the insulating sheet material 100 described herein, such as the insulating sheet material 100 at step 482, and then cutting smaller portions of material from the one or more sheets of packaging material at step 484. The method 480 also includes using the smaller portions of the insulating sheet material 201a, 201b, 201c, 301a, 301b to fabricate either a package liner or a package, such as the package liner 200 and the package 300, at step 486.

After the package liner 200 or the package 300 is fabricated, the package liner 200 or the package 300 may be used in the method 480 for shipping of a product. For example, this shipment process includes packing the package liner 200 or the package 300 with products to be delivered, such as foodstuffs, food items, or other products that must remain cold such as a meal kit, at step 488, and then shipping the package liner 200 or the package 300 and the goods packed therein to a recipient, which can be a customer, at step 490.

In the following graphs as illustrated in FIGS. 7-9, the x-axes represent time in hours (hrs) and the y-axes represent the temperature in degrees-Fahrenheit (° F.) of a test payload sample within a package liner being tested.

Tests 1, 2, and 3 as shown in FIGS. 7-9, respectively, as follows were conducted under guidelines set by the International Safe Transit Association (ISTA). More specifically, the tests for collecting the data in FIGS. 7-9 were conducted in view of the ISTA 7E 24 Hour Heat Profile standard.

FIG. 7 illustrates the results of experimental tests run on a package liner corresponding to the package liner 200 utilizing the insulating sheet material 100 and at least one other product including multiple layers of air pockets smaller than embodiments of the present disclosure.

In these experimental tests, the various embodiments and the other products were tested under the same, standardized conditions. The other products and the embodiments of the present disclosure of the package liners were filled with a test payload sample, which was one pound of hot dogs and three 16-ounce (oz) cold gel packs for a total of 48-oz, the package liners were then sealed closed, and were then cooled to an initial temperature. They were then exposed to a warmer, ambient temperature that varied over the course of 24 hours (e.g., one day), and the temperature of the test sample within the package liners were measured over the 24 hour duration of the test. The results in FIG. 7 illustrate that the package liners with a single layer of larger air pockets and sealed edges of the present disclosure perform at least similarly to other tested products. It is believed that at least part of this similarity in performance between the embodiment of the package liner including sealed edges and a single layer of larger air pockets as compared to other tested products is attributable to the embodiments of the present disclosure having a single layer of larger air pockets also including a metallic layer at an exposed surface (e.g. a surface exposed to an environment that is opposite a surface adjacent the payload) along with the sealed edges of the package liner 200. Based on the test results, it appears the metallic layer being exposed increases thermal energy and electromagnetic radiation reflectivity of the metallic layer, and the sealed edges of the package liner 200, which includes the sealed edges 212, 224 at the opening 214 of the package liner 200, decreases thermal transfer of energy into and out of the package liner 200. The package liner 200 is less expensive to manufacture compared to the other products including more layers of material (e.g., multiple layers of air pockets) as the package liner 200 and the insulating sheet material 100 have minimal layers of material that are utilized to fabricate the package liner 200.

An ambient temperature line 501 represents the ambient temperature at which the other products and embodiments of the present disclosure containing the payloads were exposed to during this experiment in “Test 1.” For example, the ambient temperature was similar or like to a sinusoidal function that fluctuates to imitate changes in an external temperature that a package liner may be exposed to during a shipping process of perishable goods to a customer.

A threshold line 503 is a selected temperature threshold, which is substantially equal to 40-degrees Fahrenheit (° F.). The selected temperature threshold was selected as it is preferred that a payload (e.g., perishable goods and foodstuffs) within a package or a package liner remains below 40-° F. to avoid the payload from becoming rancid during the shipping process before receipt by the customer.

Line 502 in the graph as shown in FIG. 7 represents data collected for “Sample 1,” which is at least one other product including multiple layers of bubbles. The “Sample 1” product is a package liner that includes bubbles 126c as shown in FIG. 10. In the package liner product of “Sample 1,” there are two layers of the bubbles 126c separated by an additional polymeric layer within each insulating sheet material. In other words, unlike the insulating sheet material 100 as shown in FIGS. 1A-1C, the insulating sheet materials of the “Sample 1” product has two layers of bubbles that are between the respective layers 102a, 104 of the insulating sheet material 100 as well as an additional polymeric layer between the two layers of bubbles. The additional polymeric layer separates the two layers of bubbles. Furthermore, the “Sample 1” package liner product does not have sealed edges unlike the package liner 200 as shown in FIGS. 2A-2D.

Line 504 in the graph as shown in FIG. 7 represents data collected for “Sample 2,” which is a package liner product that has the same or similar structure as the “Sample 1” package liner product. However, unlike the “Sample 1” package liner product, the “Sample 2” package liner has sealed edges similar to those as discussed with respect to the embodiments of the present disclosure.

Line 506 in the graph as shown in FIG. 7 represents data collected for “Sample 3,” which is a package liner of the present disclosure that has the same or similar structure as the embodiment of the package liner 200 as shown in FIGS. 2A-2D that includes the bubbles 126b as shown in FIG. 10. However, unlike the package liner 200 as shown in FIGS. 2A-2D, the “Sample 3” package liner does not have sealed edges.

Line 508 in the graph as shown in FIG. 7 represents data collected for “Sample 4,” which is the same or similar to the embodiment of the package liner 200 as shown in FIGS. 2A-2D that includes the bubbles 126b as shown in FIG. 10 and the sealed edges as shown in FIGS. 2A-2D.

The lines 502, 504 extend above the line 503 after approximately the same amount of time, which was approximately equal to 9-11-hours. Alternatively, the line 508 extended above the line 503 after a longer period of time with respect to the line 506. The line 508 for “Sample 3” extended above the line 503 after approximately 10-hours, which is similar to the performance of “Sample 1” and “Sample 2.” Alternatively, the line 506 for “Sample 4” extended above the threshold line 503 after approximately 7-8-hours.

In view of these results, the performance of the package liner 200 with the bubbles 126b and the sealed edges of “Sample 4” kept the payload colder for longer (e.g., below the threshold line 503) as compared to the embodiments of the package liner of the present disclosure having the bubbles 126b and not having the sealed edges as in “Sample 3.” Unlike the line 506, which extended above the line 503 before any of the other package liners that were tested, the line 508 for “Sample 4,” which is the package liner 200, performed similarly to the package liners of “Sample 1” and “Sample 2.” Accordingly, the sealed edges of the “Sample 4” appear to have allowed the hot dogs to remain colder for longer as compared to “Sample 3” and “Sample 4,” and “Sample 4” is less expensive to manufacture as compared to the package liners of “Sample 1” and “Sample 2,” respectively, as the package liner 200 of “Sample 4” has fewer layers as compared to the package liners of “Sample 1” and “Sample 2.”

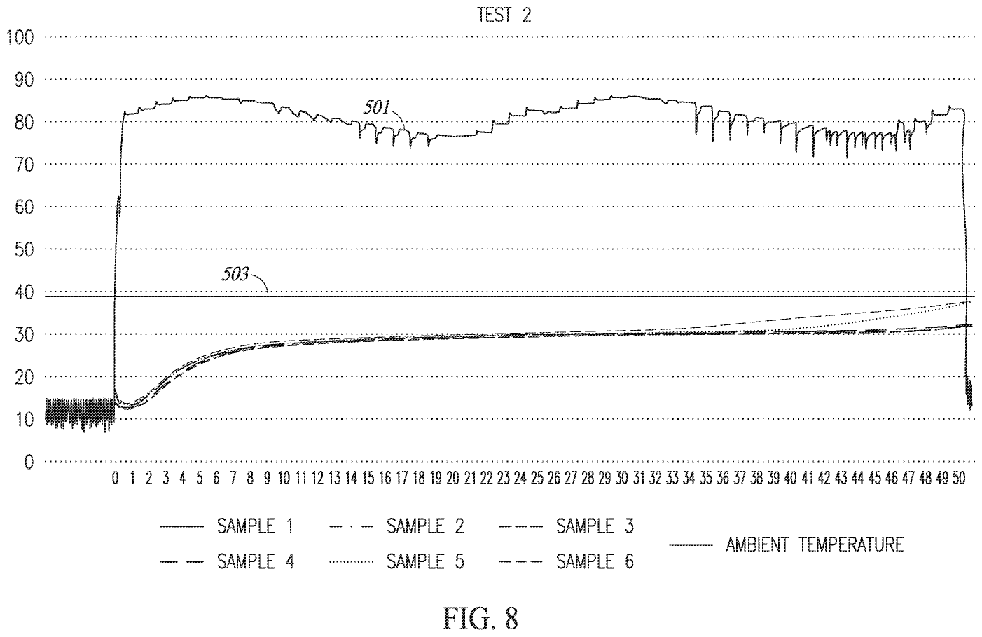

FIG. 8 illustrates the results of experimental tests run on a package liner corresponding to the package liner 200 utilizing the insulating sheet material 100 as well as at least one other product including multiple layers of air pockets. In these experimental tests, the other products were tested under the same, standardized conditions. The other products and the embodiments of the present disclosure of the package liners were filled with a test payload sample, which was three pounds of beef and three 96-ounces (oz) of cold gel packs (e.g., a total of 288-oz), the package liners were then sealed closed, and were then cooled to an initial temperature. They were then exposed to a warmer, ambient temperature that varied over the course of 48 hours (e.g., two days), and the temperature of the test payload samples within the package liners were measured over the 48-hour duration of the test. The results in FIG. 8 illustrate that the package liners including a single layer of bubbles of the present disclosure described herein performed at least similar to the other tested products. It is believed that at least part of this improvement is attributable to the systems of the present disclosure including a metallic layer having an exposed surface, e.g. a surface exposed to an environment that is opposite a surface adjacent the payload, which increases thermal energy and electromagnetic radiation reflectivity of the metallic layer, along with the sealed edges of the package liner 200. However, the package liner 200 is less expensive to manufacture as compared to other package or package liner products as the package liner 200 and the insulating sheet material 100 have minimal layers of material that are utilized to fabricate the package liner 200.

The package liners of “Sample 1,” “Sample 2,” and “Sample 3” are the same or similar to the other package liner product of “Sample 1” as discussed earlier with respect to FIG. 7. The solid lines of the graph in FIG. 8 represent the data collected during this experiment for the package liners of “Sample 1,” “Sample 2,” and “Sample 3.”

The package liners of “Sample 4,” “Sample 5,” and “Sample 6” are the same or similar to the package liner 200 of “Sample 4” as described within the present disclosure and discussed earlier with respect to FIG. 7. Dotted and dashed lines of the graph in FIG. 8 represent the data collected during this experiment for the package liner 200 of the embodiment of the present disclosure of “Sample 4,” “Sample 5,” and “Sample 6.”

As shown in FIG. 8, the package liners of the samples in FIG. 8 kept the payload within the Samples below 40 degrees-Fahrenheit (° F.) for over a period of 48-hours. Accordingly, while the performance of the package liners are all the same or similar to each other, as set forth earlier, the package liner 200 of “Sample 4,” “Sample 5,” and “Sample 6,” are less expensive to manufacture as compared to the package liner of “Sample 1,” “Sample 2,” and “Sample 3. The package liner 200 of “Sample 4,” “Sample 5,” and “Sample 6,” has fewer layers compared to the package liner of “Sample 1,” “Sample 2,” and “Sample 3,” and the package liner 200 provides similar performance to the package liner of “Sample 1,” “Sample 2,” and “Sample 3.”

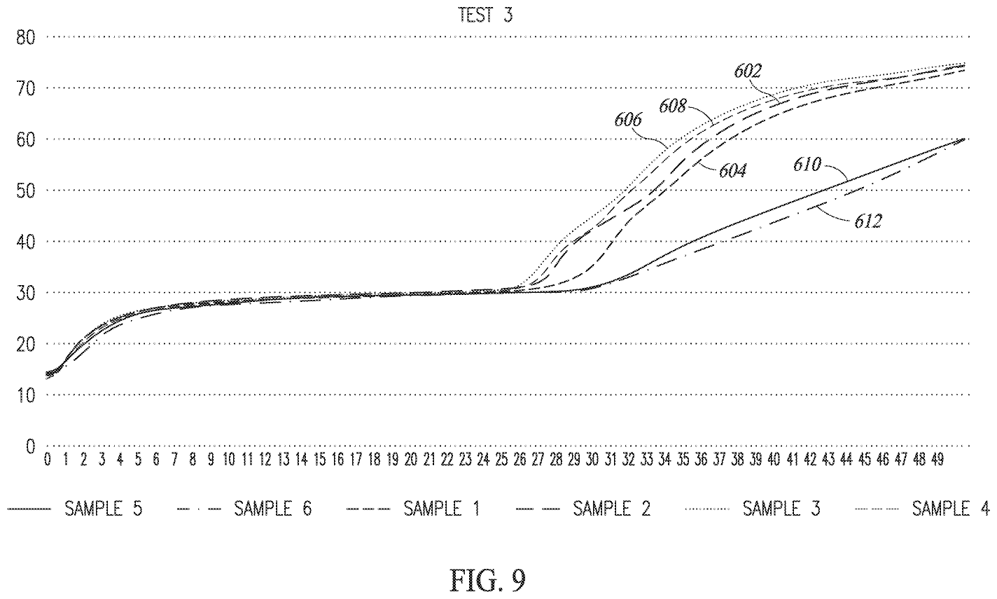

FIG. 9 illustrates the results of experimental tests run on a package liner corresponding to the package liner 200 utilizing the insulating sheet material 100 as well as at least one other product. In these experimental tests, the various products were tested under the same, standardized conditions. The products were filled with a test payload sample, which was either 48-ounces (oz) or 192-ounces (oz) of cold gel packs in total, were sealed closed, and then cooled to an initial temperature. In other words, the amount of ice packs, cold packs, dry ice packs, or cold gel packs was varied in the experimental tests used to generate the FIG. 9 data. For example, some of the tests included 192-ounces (oz) of cold packs and some of the tests instead included 48-ounces (oz) of cold packs. They were then exposed to a warmer, ambient temperature that varied over the course of 48 hours (e.g., two days), and the temperature of the test payload samples within the package liners were measured over the 48 hour duration of the test. The results in FIG. 9 illustrate that the package liners of the present disclosure described herein perform at least similar to the tested other products. It is believed that at least part of this improvement is attributable to the systems of the present disclosure including a metallic layer having an exposed surface, e.g. a surface exposed to an environment that is opposite a surface adjacent the payload, which increases thermal energy and electromagnetic radiation reflectivity of the metallic layer, along with the sealed edges of the package liner 200. However, the package liner 200 is significantly less expensive to manufacture compared to the other products including more layers of material as the package liner 200 has minimal layers of material that are utilized to fabricate the package liner 200.

“Sample 1” and “Sample 2” are the same or similar to the other package liner product of “Sample 1” as discussed earlier with respect to FIG. 7. Solid lines of the graph in FIG. 8 represent the data collected during this experiment for “Sample 1” and “Sample 2.” Lines 602, 604 of the graph in FIG. 9 represent the data collected during this experiment for the other package liner products of “Sample 1” and “Sample 2” when the other package liner products of “Sample 1” and “Sample 2” are filled with 48-oz of cold gel packs and three pounds of beef.

“Sample 3,” “Sample 4,” “Sample 5,” and “Sample 6,” are the same or similar to the package liner 200 of the embodiments of the present disclosure of “Sample 4” as described within the present disclosure and discussed earlier with respect to FIG. 7. Lines 606, 608, 610, 612 of the graph in FIG. 9 represent the data collected during this experiment for the package liner 200 of “Sample 3,” “Sample 4,” “Sample 5,” and “Sample 6.” Lines 606, 608 of the graph in FIG. 9 represent the data collected during this experiment when the package liner 200 of “Sample 3” and “Sample 4” are filled with 48-oz of cold gel packs and three pounds of beef. Lines 610, 612 of the graph in FIG. 9 represent the data collected during this experiment for the package 200 of “Sample 5,” and “Sample 6,” are filled with 192-oz of cold gel packages and three pounds of beef.

The package liners of “Sample 1,” “Sample 2,” “Sample 3,” and “Sample 4,” when filled with 48-oz of cold gel packs and three pounds of beef had the same or similar performance to each other such that profiles of the lines 602, 604, 606, 608 have the same or similar pattern or shape to each other. Accordingly, while the performance of the other package liner products of “Sample 1” and “Sample 2” and the package liner 200 of the present disclosure of “Sample 3” and “Sample 4” are the same or similar to each other, as set forth earlier, the package liner 200 of “Sample 3” and “Sample 4” is less expensive to manufacture as compared to the other package liner products of “Sample 1” and “Sample 2.” The package liner 200 of the present disclosure is less expensive to manufacture as the package liner 200 has fewer layers compared to the package liner of “Sample 1” and “Sample 2.”

When the amount of cold gel packs was increased to 192-oz in the package liner 200 of “Sample 5” and “Sample 6,” a second half of the lines 610, 612 had a linear progression unlike the lines 602, 604, 606, 608. This linear progression allows for a more consistent warming of the test payload sample within the package liner, which provides a shipper with a relatively predictable result when utilizing the package liner 200 when shipping a perishable good to a customer with the use of 192-oz of cold gel packs. In other words, the shipper may simple adjust the amount of ice gel packs placed within the package liner 200 such that the perishable good will not likely become rancid before receipt by the customer.

FIG. 10 is directed to different shapes and sizes of embodiments of the air pockets 126 as shown in FIG. 1A-1C. The upper images are top plan views of various embodiments 126a, 126b, 126c of the air pockets 126, and the lower images are corresponding cross-sections of the various embodiments 126a, 126b, 126c of the air pockets.

As shown on the left-hand side images of FIG. 10, a first embodiment 126a has a diameter of 1.18-inches (30-millimeters), a cylindrical depth of 0.5-inches, and a total depth (e.g., the thickness T1 as shown in FIG. 1C) of 0.44-inches (11.176-millimeters). For example, referencing the dimensions in FIG. 1C, the thickness T1 of first embodiment 126a may range from 0.34-inches to 0.50-inches, and the diameter D1 of the first embodiment 126a may be substantially equal to 1.181-inches.

As shown in the middle images of FIG. 10, a second embodiment 126b has a diameter of 0.984-inches (25-millimeters), a cylindrical depth of 0.3125-inches, and a total depth (e.g., the thickness T1 as shown in FIG. 1C) of 0.33-inches (8.382-millimeters). For example, referencing the dimension in FIG. 1C, the thickness T1 of second embodiment 126b may range from 0.26-inches to 0.40-inches, and the diameter D1 of the second embodiment 126b may be substantially equal to 0.984-inches. The second embodiment 126b is the preferred option to be utilized within the insulating sheet material 100, the package liner 200, and the package 300.

As shown in the right-hand side images of FIG. 10, a third embodiment 126c, which may be referred to as a 3/16-inch (in) bubble, has a diameter of 0.394-inches (10-millimeters), a cylindrical depth of 0.1875-inches, and a total depth (e.g., the thickness T1 as shown in FIG. 1C) of 0.16-inches (4.064-millimeters). For example, referencing the dimension in FIG. 1C, the thickness T1 of second embodiment 126b may range from 0.12-inches to 0.20-inches, and the diameter D1 of the second embodiment 126b may be substantially equal to 0.394-inches.

In accordance with some embodiments of the present disclosure, use of bubbles of larger diameters (embodiments 126a, 126b) would be preferred over using bubbles of smaller diameter (embodiments 126c). While it is generally believed that the use of smaller bubbles results is less convective heat transfer, the present inventors have observed, as reflected by the data in FIGS. 7-9, utilizing the preferred embodiment 126b (bubbles of larger diameter) for the air pockets 126 along with the sealed edges as discussed earlier within the present disclosure at least slightly improved the package liner's 200 convective heat transfer as compared to utilizing the smaller bubbles (e.g., air pockets 126c). In other words, the package liners 200 with the preferred embodiment 126b of the air pockets 126 generally reduced the effects of convective heat transfer as compared to when the smaller bubbles 126c were utilized.

In some other embodiments, the insulating sheet material 100, the package liner 200, and the package 300 may utilized air pockets 126 with different sizes or shapes than those as shown in FIG. 10.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An insulating material, comprising:
a first polymeric layer having:
a first side and a second side opposite to the first side;
a first edge; and
a first thickness extending from the first side to the second side of the first polymeric layer;
a metallic layer at the first side of the first polymeric layer, the metallic layer having a second thickness less than the first thickness;
a second polymeric layer having:
a first side and a second side opposite to the first side; and
a second edge sealed to the first edge of the first polymeric layer;
a third polymeric layer having:
a first side and a second side opposite to the first side; and
a layer of air pockets having first ends attached to the first side of the second polymeric layer and second ends attached to the second side of the first polymeric layer.

2. The insulating material of claim 1, wherein the first thickness and the second thickness summed together ranges from 3-mil (thousands of an inch) to 4-mil.

3. The insulating material of claim 1, wherein the second thickness of the metallic layer ranging from 200-Å (angstroms) to 350-Å.

4. The insulating material of claim 1, wherein the second polymeric layer further includes a third thickness extending from the first side to the second side of the second polymeric layer less than the first thickness and the second thickness summed together.

5. The insulating material of claim 4, wherein:
the first thickness and the second thickness summed together ranges from 3-mil to 4-mil; and
the third thickness being substantially equal to 2.5-mil.

6. The insulating material of claim 5, wherein the third polymeric layer further includes:
a second side opposite to the first side; and
a fourth thickness extending from the first side to the second side of the third polymeric layer, the fourth thickness being substantially equal to 2-mil.

7. The insulating material of claim 6, wherein each respective air pocket of the plurality of air pockets having a cylindrical portion having a depth extending from a respective second end, the depth ranging from 0.3125-in (inches) to 0.5-in.

8. The insulating material of claim 1, wherein the metallic layer is an aluminum material.

9. A package, including:
a first end and a second end opposite to the first end;
a first side and a second side opposite to the first side, the first side and the second side being transverse the first end and the second end;
a cavity between the first end and the second end, the cavity being between the first side and the second side;
an opening at the first end and in fluid communication with the cavity, the opening having a first sealed edge and a second sealed edge opposite to the first sealed edge, the first and second sealed edges extending from the first side to the second side;
a third sealed edge at the second end, the third sealed edge extending from the first side to the second side;
a fourth sealed edge at the first side, the fourth sealed edge extending from the first end to the second end;
a fifth sealed edge at the second side, the fifth sealed edge extending from the first end to the second end;
an exterior surface and an interior surface opposite to the exterior surface;
a metallized polymeric layer at the exterior surface;
a second polymeric layer at the interior surface; and
a third polymeric layer extending from the first polymeric layer to the second polymeric layer, the third polymeric layer abuts the first polymeric layer and the second polymeric layer.

10. The package of claim 9, further comprising the metallized polymeric layer includes a metallic layer on a first polymeric layer, the metallic layer exposed at the exterior surface.

11. The package of claim 10, wherein the metallized polymeric layer having a first thickness ranging from 3-mil (thousands of an inch) to 4-mil.

12. The package of claim 11, wherein the metallic layer of the metallized polymeric layer includes a second thickness ranging from 200-Å (angstroms) to 350-Å.

13. The package of claim 12, wherein the second polymeric layer having a third thickness substantially equal to 2.5-mil.

14. The package of claim 13, wherein the third polymeric layer having a fourth thickness substantially equal to 2-mil.

15. The package of claim 9, further comprising a plurality of air pockets between the first polymeric layer and the second polymeric layer, the plurality of air pockets defined by the third polymeric layer.

16. The package of claim 9, further comprising a plurality of voids between the first polymeric layer of the metallized polymeric layer and the second polymeric layer, the plurality of voids extending between adjacent ones of the plurality of air pockets.

17. The package of claim 9, wherein the first, second, third, fourth, and fifth sealed edges are heat-sealed edges.

18. A package, comprising:
a first end and a second end opposite to the first end;
a first side and a second side opposite to the first side, the first and second sides extending from the first end to the second end;
an exterior surface and an interior surface;
a first insulating sheet and a second insulating sheet opposite to the first insulating sheet, the first and second insulating sheets including:
a metallized polymeric layer at the exterior surface, the first metallized polymeric layer having a first thickness ranging from 3-mil (thousands of an inch) to 4-mil;
a first polymeric layer at the interior surface, the first polymeric layer having a second thickness of 2.5-mil;
a second polymeric layer between the metallized polymeric layer and the first polymeric layer, the second polymeric layer having a third thickness of 2-mil, the second polymeric layer extending from the metallized polymeric layer to the first polymeric layer; and
a plurality of air pockets between the metallized polymeric layer and the first polymeric layer, the plurality of air pockets defined by the second polymeric layer;
a first sealed edge at the first end sealing the first insulating sheet to the second insulating sheet;
a second sealed edge at the first side sealing the first insulating sheet to the second insulating sheet;
a third sealed edge at the third side sealing the first insulating sheet to the second insulating sheet;
an opening extending from the first insulating sheet to the second insulating sheet, the opening spacing apart the first insulating sheet from the second insulating sheet; and
a cavity between the first insulating sheet and the second insulating sheet, the cavity in fluid communication with the opening.

19. The package of claim 18, wherein:
the first insulating sheet includes a fourth sealed edge adjacent to the opening, the fourth sealed edge extending from the first side to the second side; and
the second insulating sheet includes a fifth sealed edge adjacent to the opening, the fifth sealed edge extending from the first side to the second side.

20. The package of claim 18, wherein the metallized polymeric layer includes:
a third polymeric layer; and
a metallic layer on the third polymeric layer, the metallic layer having a fourth thickness ranging from 200-Å (angstroms) to 350-Å, the metallic layer spaced apart from the first and second polymeric layers by the third polymeric layer.

21. An insulating material, comprising:
a metallized polymeric layer including:
a first side and a second side opposite to the first side;
a first edge; and
a first thickness extending from the first side to the second side of the metallized polymeric layer;
a first polymeric layer including:
a first side and a second side opposite to the first side;
a second edge sealed to the first edge of the metallized polymeric layer; and
a second polymeric layer having:
a first side; and
a layer of air pockets having first ends attached to the first side of the second polymeric layer and second ends attached to the second side of the metallized polymeric layer.

22. The insulating material of claim 21, wherein the metallized polymeric layer includes:
a polymeric layer having a first surface and a second surface opposite to the first surface, the first surface facing towards the first and second polymeric layers, the second surface facing away from the first and second polymeric layers; and
a metallic layer on the second surface of the polymeric layer, the metallic layer having a third surface facing away from the polymeric layer.

23. The insulating material of claim 22, wherein the metallic layer has a thickness extending from the third surface to the second surface of the polymeric layer ranging from 200-Å (angstroms) to 350-Å.

24. The insulating material of claim 21, wherein the metallized polymeric layer has a first thickness ranging from 3-mil (thousands of an inch) to 4-mil.

25. The insulating material of claim 24, wherein a metallic layer of the metallized polymeric layer has a second thickness ranging from 200-Å (angstroms) to 350-Å.
